(19) United States
(12) Patent Application Publication
(10) Pub. No.: US 2019/0174945 A1
(43) Pub. Date: Jun. 13, 2019

(54) PREPARATION VESSEL FOR A FOOD PROCESSOR

(71) Applicant: Vorwerk & Co. Interholding GmbH, Wuppertal (DE)

(72) Inventor: Benjamin OTI, Wuppertal (DE)

(73) Assignee: Vorwerk & Co. Interholding GmbH, Wuppertal (DE)

(21) Appl. No.: 16/215,897

(22) Filed: Dec. 11, 2018

(30) Foreign Application Priority Data
Dec. 12, 2017 (DE) 20 2017 107 544.3

(51) Int. Cl. A47J 27/04; A47J 27/00

(52) U.S. Cl. CPC A47J 27/04; A47J 27/004

(57) ABSTRACT

A preparation vessel for a food processor has a vessel wall, at least a partial area of which has a double-wall configuration, with an inner wall that borders a preparation chamber of the preparation vessel and an outer wall designed separately from the latter and spaced apart from the inner wall by an intermediate space. In order to optimize such a preparation vessel with respect to both heating and/or heat retention as well as outward insulation, the intermediate space has a vacuum with a gas pressure of less than 300 mbar and/or an insulating material with a thermal conductivity of less than 0.02 W/(mK).

### CROSS-REFERENCE TO RELATED APPLICATIONS

This application claims priority under 35 USC 119 of German Patent Application No. 20 2017 107 544.3, filed on Dec. 12, 2017, the disclosure of which is herein incorporated by reference.

### FIELD OF TECHNOLOGY

The invention relates to a preparation vessel for a food processor, wherein the preparation vessel has a vessel wall, at least a partial area of which has a double-wall configuration, with an inner wall that borders a preparation chamber of the preparation vessel and an outer wall designed separately from the latter and spaced apart from the inner wall by an intermediate space.

The invention further relates to a food processor with a base unit and with a preparation vessel that can be connected with the base unit and has the design described above.

### THE PRIOR ART

Preparation vessels and food processors with such preparation vessels are known in prior art.

For example, publications DE 10 2014 112 959 A1 and DE 10 2014 113 552 A1 disclose food processors designed as combined cooking/mixing devices. The food processor has a base unit, with which a preparation vessel can be connected. For example, the preparation vessel is a mixing vessel, a floor area of which has an agitator, which can be rotated by means of an electric motor arranged in the base unit. A vessel wall of the preparation vessel, for example a vessel floor, has a heating device. The latter is usually designed as a thick-film heater, and embedded into the material of the vessel floor. The mixing vessel is connected with another preparation vessel, which in the aforementioned publications is designed as a cooking attachment. The cooking attachment has one or more floor openings, through which steam exiting the mixing vessel can enter into the cooking attachment, and condensate can flow out of the cooking attachment into the mixing vessel.

Also described is that a cooking attachment has a heating device, which permits a faster and more uniform cooking and/or ensures that meals are kept warm after preparation. Also known is to at least partially give the cooking attachment wall a double-walled design. The two walls, i.e., the inner wall and outer wall, are spaced apart from each other by an intermediate space, for example one filled with air.

### SUMMARY OF THE INVENTION

Proceeding from the aforementioned prior art, the object of the invention is to further develop preparation vessels for food processors in such a way that meals located in the preparation chamber can be optimally, preferably homogeneously, heated and/or kept warm, while at the same time ensuring an optimal outward insulation, so that a user is not exposed to heat when touching the outer wall.

In order to achieve the aforementioned object, it is proposed that the intermediate space of the vessel wall of the preparation vessel have a vacuum with a gas pressure of less than 300 mbar and/or that the intermediate space have an insulating material with a thermal conductivity of less than 0.02 W/(mK).

According to the invention, the vessel wall is now equipped with an improved insulating function by comparison to prior art, in that the intermediate space is to an increased extent designed so that heat cannot be emitted from the inner wall to the outer wall or vice versa. According to the prior art described above, the preparation vessel can involve either a vessel that can be connected with a base unit of a food processor, or an additional vessel, for example a cooking attachment, which can in turn be connected with the aforementioned vessel. The inventive intermediate space of the vessel wall of the preparation vessel improves the insulating effect by further reducing the thermal conductivity of the insulating material used therein or by generating a vacuum. This prevents or at least greatly reduces the outward thermal transport through the vessel wall. In the technical conjunction of interest here, a vacuum is basically understood as the state of a gas in which the pressure of the gas measures less than 300 mbar. As opposed to an intermediate space filled with air, in which the gas pressure usually measures roughly 1 bar, lowering the gas pressure reduces heat transfer. Alternatively or additionally to a vacuum inside of the intermediate space of the vessel wall, use can also be made of an insulating material having a thermal conductivity less than the thermal conductivity of air, here a thermal conductivity of less than 0.026 W/(mK).

In particular, it is proposed that the gas pressure be less than 100 mbar, preferably less than 50 mbar. Gas pressures of less than 10 mbar or less than 1 mbar can preferably be provided. The gas pressure of the vacuum within the intermediate space is basically limited only by the stability and gas tightness of the inner wall and outer wall. In addition, the lower the desired gas pressure, i.e., the more strongly the intermediate space is to be evacuated, the higher the outlay required while generating the vacuum. In practice, gas pressures of less than 300 mbar, and in particular gas pressures of up to 1 mbar, are already sufficient to diminish the heat transfer between the inner wall and outer wall or vice versa so significantly that a user of the preparation vessel notices no significant temperature increase on the outer wall of the preparation vessel during an ongoing conventional preparation process in the preparation chamber of the preparation vessel at temperatures of up to 120° C. or more, for example.

In addition, it is proposed that the insulating material have a silica, an aerogel, an open-pore polymer foam and/or glass fibers. Especially suitable as a filler for the intermediate space are open-pore polymer foams, for example polyurethane or polystyrene foams. In addition, use can also be made of glass fibers, silica particles or aerogels. The insulating material incorporated into the intermediate space is preferably designed in such a way as to have the lowest possible specific weight, so that this does not significantly increase the dead weight of the preparation, and the user does not endure any diminished comfort. Therefore, foams are particularly suited. The open pores of the foams can additionally be evacuated, and have a vacuum with a gas pressure of less than 300 mbar. In addition, the selected insulating material should also be food-safe, just in case damage to the preparation vessel causes insulating material to exit.

It is proposed that the vessel wall be a circumferential wall of the preparation vessel. The double-wall feature of the vessel wall preferably involves the entire shell surface of the vessel. In addition, a vessel floor of the preparation vessel can also be double-walled in design. In particular, the vessel wall can have a continuous intermediate space. For example, this is advantageous when generating a vacuum. Alternatively, the intermediate space can be divided into individual chambers, for example so that the insulating material can only wander into the respective chamber, but not unlimitedly within the entire vessel wall. As a result of the insulating function according to the invention, for example, the user cannot scald him or herself when lifting up the preparation vessel. By insulating the entire circumferential wall of the preparation vessel, heat can essentially only escape through an opening of the preparation chamber, while this can in turn be prevented by using a cover. In this conjunction, it can be provided that the cover also be double-walled in design, and have an inner wall and outer wall separated by an intermediate space, in which a vacuum is generated with a gas pressure of less than 300 mbar and/or an insulating material with a thermal conductivity of less than 0.02 W/(mK) is incorporated.

In addition, the invention proposes a preparation vessel for a food processor having a vessel wall that is formed at least in a partial area with double walls, with an inner wall that borders a preparation chamber of the preparation vessel and an outer wall formed separately thereto and spaced apart from the inner wall by an intermediate space, wherein the intermediate space accommodates a heating device and/or cooling device that contacts the inner wall in a heat conducting manner. For example, a thick-film heater, a Peltier element, a heating resistor or the like can be used as a heating device. For example, a Peltier element, a flow channel for cold water or the like can be provided as the cooling device. Apart from the proposed heating device and/or cooling device proposed here, the intermediate space can further also have a vacuum with a gas pressure of less than 300 mbar and/or an insulating material with a thermal conductivity of less than 0.02 W/(mK), as proposed above. In this embodiment, however, the intermediate space is used not just for thermal insulation, but rather also for introducing thermal energy into the preparation chamber, and thus into the preparation material located in the preparation vessel. To this end, the inner wall of the vessel wall is preferably thermally conductive in design, so that the heat on the preparation chamber can be dissipated. The heating device contacts the inner wall in a thermally conductive manner. In like manner, a cooling device can alternatively or additionally be provided within the intermediate space. The cooling device also contacts the inner wall in a thermally conductive manner, so that thermal energy can optionally also be dissipated from the preparation chamber or foods or meals located therein to the cooling device. As a result, foods and meals located inside of the preparation chamber are cooled. For example, this function is advantageous when making whipped cream, preparing ice cream or mousse and the like. As opposed to prior art, a user need no longer place the preparation vessel into a refrigerator or freezer for a certain time before preparing such foods. The cooling device further makes it possible to keep the outer wall of the vessel wall cool even though a hot food is located inside of the preparation chamber, so that the user can touch the outside of the preparation vessel. For example, this configuration can also provide that the cooling device be allocated only to the outer wall of the intermediate space, so that the cooling device does not simultaneously also end up cooling a hot meal located inside of the preparation chamber. Depending on the function desired for the preparation vessel or food processor, the cooling device can be arranged and formed inside of the intermediate space in such a way that it can be displaced either toward the inner wall or outer wall, so that either the inner wall or outer wall is cooled. As a consequence, emphasis is placed on the function of either cooling the preparation chamber of the preparation vessel, or keeping the outer wall cool.

It is proposed that the heating device and/or cooling device be thermally insulated relative to the outer wall. The thermal insulation can be achieved either by generating a vacuum between the heating device or cooling device and the outer wall, or by introducing a previously mentioned insulating material. As a consequence, the heat generated by the heating device or the cold generated by the cooling device does not get to the outer wall, so that the vessel wall of the preparation vessel is always preferably at ambient temperature.

It can be provided that the intermediate space between the outer wall and the heating device and/or cooling device have a vacuum with a gas pressure of less than 300 mbar and/or an insulating material with a thermal conductivity of less than 0.02 W/(mK). Viewed from the inside out, the vessel wall of the preparation vessel thus initially has the inner wall, then a heating device or cooling device that is in contact with the inner wall in a thermally conductive manner, and then either a vacuum with the aforementioned gas pressure or a corresponding insulating material. The outer wall of the vessel wall then follows, without contact to the heating device or cooling device.

It is proposed that the preparation vessel be a preparation vessel that can be connected with a base unit of a food processor, and has electrical connections for connection to a power supply of the base unit. In this embodiment, energy is drawn from the base unit of the food processor by the preparation vessel, in particular by a heating device and/or cooling device, but also by sensors or other consumers, for example. For example, the electrical connections can consist of contact pins on a vessel floor or some other partial area of a vessel wall of the preparation vessel, which can be connected with corresponding sockets of the base unit. The preparation vessel can further also have a vessel floor with a floor opening, through which an agitator can be guided into the preparation chamber. The agitator can be operated by means of an electric motor located in the base unit.

It is further proposed that a vessel floor of the preparation vessel have a heating device and/or cooling device. According to this embodiment, the preparation vessel can have a heating device and/or cooling device only in the vessel floor, or additionally in the area of a circumferential wall of the preparation vessel too, as already proposed before. It is likewise possible to equip only individual partial areas of the circumferential wall and/or vessel floor with a heating and/or cooling function. The heating device or cooling device can be divided into individual heating or cooling segments, or integrally traverse the entire vessel wall.

Finally, proposed apart from the preparation vessel described above as well, is a food processor with a base unit and a preparation vessel that can be connected with the base unit, wherein the preparation vessel is designed according to one or several of the embodiments proposed above. For example, the food processor can be a combined cooking/mixing device, on whose base unit a preparation vessel can be arranged. In particular, the base unit of the food processor can provide the power supply for the heating device and/or cooling device of the preparation vessel, or also energy for sensors, an electric motor for driving an agitator and the like.

### BRIEF DESCRIPTION OF THE DRAWINGS

The invention will be explained in greater detail below based on exemplary embodiments. As shown in the drawings:

FIG. 1 is a food processor according to the invention with a preparation vessel,

FIG. 2 is a longitudinal section through the food processor according to FIG. 1,

FIG. 3 is a preparation vessel according to the invention based on a first embodiment,

FIG. 4 is a preparation vessel according to the invention based on a second embodiment,

FIG. 5 is a preparation vessel according to the invention based on a third embodiment.

### DESCRIPTION OF THE EMBODIMENTS

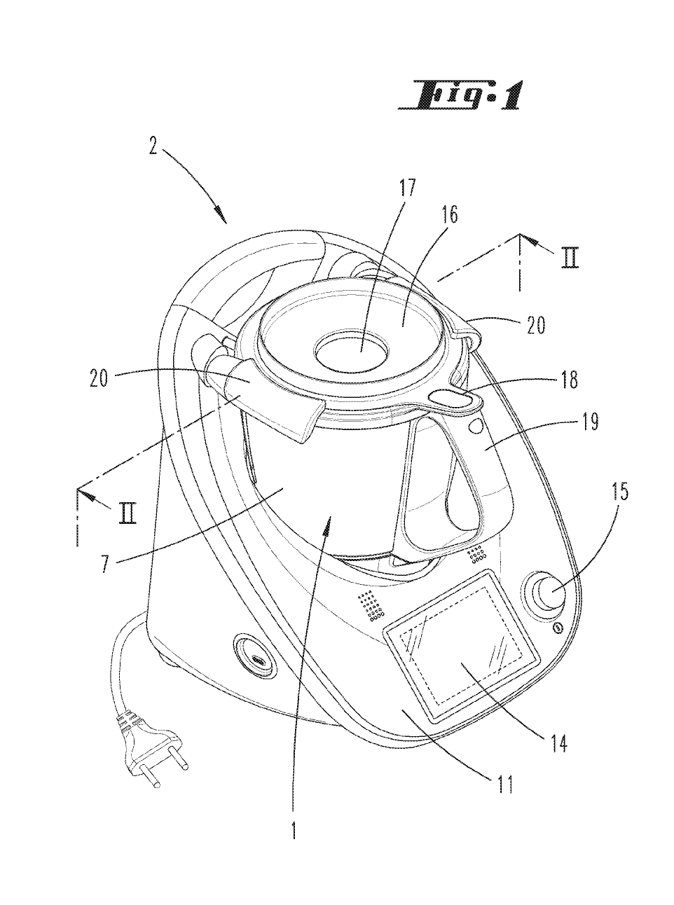

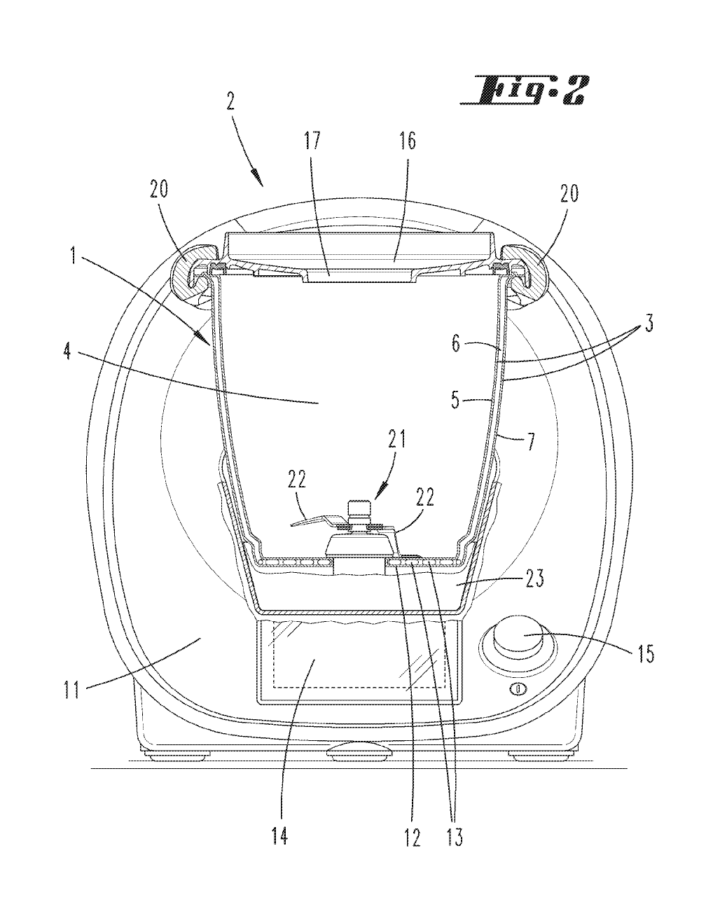

FIG. 1 only exemplarily shows an electric motor-driven food processor 2, which is here designed as a combined cooking/mixing device. For example, the food processor 2 has a base unit 11 for detachably accommodating a preparation vessel 1. A vessel floor 12 of the preparation vessel 1 (see FIG. 2) here has a floor opening, through which can be passed part of an agitator 21 that is connected with a motor shaft of an electric motor of the food processor 2. The preparation vessel 1 further has a vessel handle 19 and a cover 16 with a cover handle 18 and a cover opening 17. For example, the cover opening 17 makes it possible to add ingredients into the preparation vessel 1 during operation of the food processor 2. Also arranged on the base unit 11 are a display 14, here for example a touchscreen, as well as a switch 15, which can be used to control a menu guide of the food processor 2, for example to control the preparation of meals based on a selected recipe. For example, the display 14 can show the user individual processing steps involved in an automatic recipe preparation, as well as required ingredients for the preparation that the user must add to the preparation vessel 1. For example, the switch 15 allows the user to confirm an input, initiate individual processing steps and the like. The cover 16 of the preparation vessel 1 is fixed to the preparation vessel 1 using two locking rollers 20, so that the preparation vessel 1 cannot undesirably open during an operation of the food processor 2.

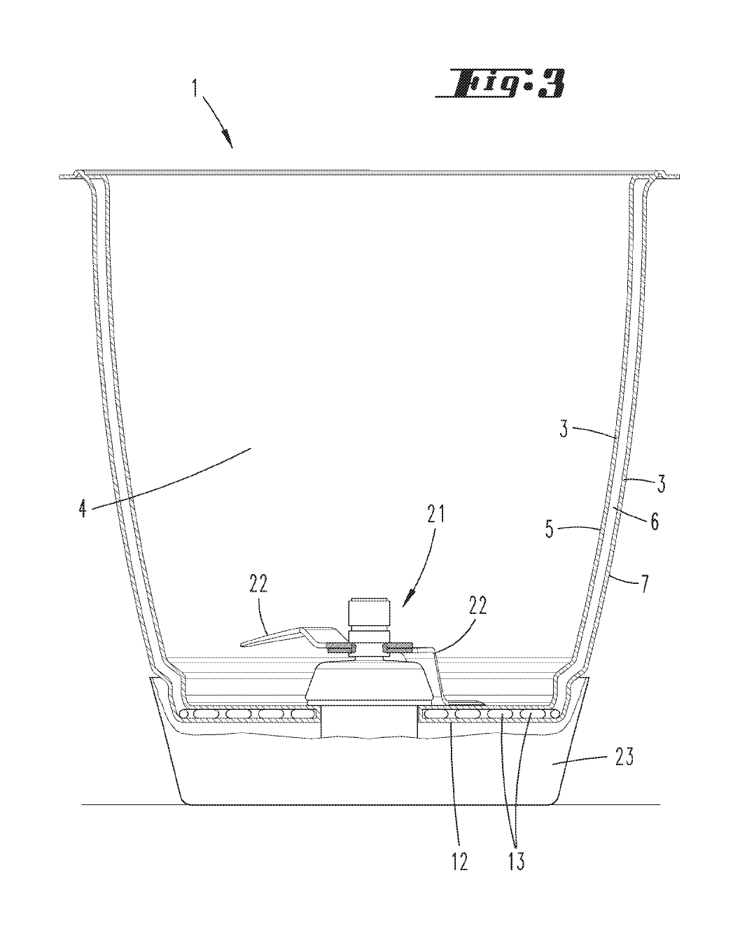

FIG. 2 shows the food processor 2 with a longitudinally cut preparation vessel 1 according to a first embodiment. The preparation vessel 1 is also shown magnified on FIG. 3. The base unit 11 of the food processor 2 has a device receiving area, with which the preparation vessel 1 is detachably connected. For example, the vessel receiving area is here shaped like a depression, into which the preparation vessel 1 can be placed. The vessel receiving area can have electrical contacts, which provide a power supply for electrical consumers of the preparation vessel 1. To this end, for example, a strip with contacts can be formed on the vessel receiving area, with which corresponding electrical contacts of the preparation vessel 1 can be connected. The preparation vessel 1 here has a vessel foot part 23, which forms a standing surface for the preparation vessel 1. The preparation vessel 1 is connected with this vessel foot part 23, preferably detachably. For example, the vessel foot part 23 can serve to fix the agitator 21 to the vessel floor 12 of the preparation vessel 1. The agitator 21 is here designed as a set of knives with a plurality of knives 22. The vessel floor 12 further accommodates a heating device 13. For example, the heating device 13 is here integrated as a thick-film heating device in the material of the vessel floor 12, and is supplied with electrical energy via the power supply of the base unit 11 of the food processor 2.

The preparation vessel 1 has a vessel wall 3, which comprises the circumferential surface of the preparation vessel 1 along with its vessel floor 12. The vessel wall 3 is here double-walled in design, with an inner wall 5 and an outer wall 7 spaced apart from the inner wall 5. The inner wall 5 and outer wall 7 are separated by an intermediate space 6. The intermediate space 6 is exposed to a low pressure here measuring 200 mbar, for example. This relates to the entire intermediate space 6 of the vessel wall 3, except in this case for the area of the vessel floor 12, for example, in which the heating device 13 is arranged.

The vacuum established in the intermediate space 6 serves to thermally insulate a preparation chamber 4 of the preparation vessel 1 relative to the environment. The vacuum interrupts a thermally conductive connection that might otherwise be present between the inner wall 5 and outer wall 7. Because the walls 5, 7 are thermally decoupled by the vacuum, a meal located in the preparation chamber 4 cools off less rapidly, and its thermal energy cannot be released to the outer wall 7 of the preparation vessel 1. Despite the hot preparation material inside of the preparation chamber 4, the outer wall 7 remains cold, and cannot burn a user even at high temperatures, should he or she touch the outer wall 7 of the preparation vessel 1. The inner wall 5 is preferably made out of a thermally conductive material, for example a metal, so that the preparation chamber 4 and preparation material located therein can be heated as uniformly as possible and kept warm. The preparation material can thus retain a temperature over a longer period of time by comparison to prior art, since no temperature compensation with the environment of the preparation vessel 1 takes place.

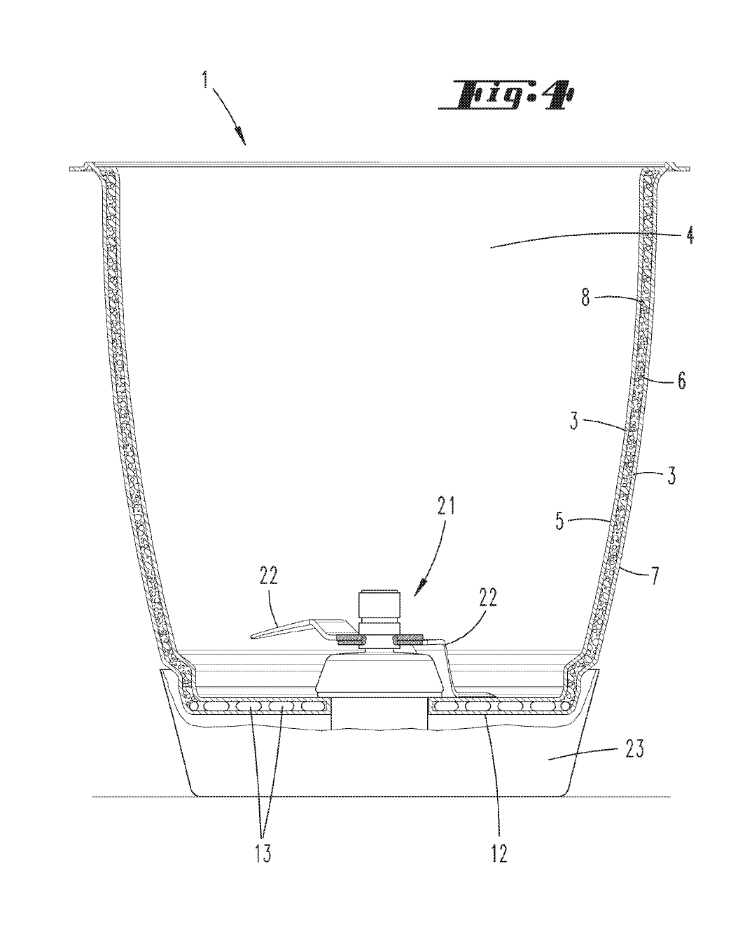

FIG. 4 shows another possible embodiment of a preparation vessel 1 according to the invention. In this example, the double-walled vessel wall 3 of the preparation vessel 1 has an insulating material 8 relative to the circumferential wall having a thermal conductivity less than that of air. For example, the insulating material 8 here has a thermal conductivity of less than 0.02 W/(mK). For example, the insulating material 8 consists of an open-pore polymer foam or an aerogel. In addition, other materials are possible, for example silica, glass fibers, other plastic insulating materials and the like. In addition to the insulating material 8, it can be provided that a vacuum be applied in partial areas of the intermediate space 6 free of materials, for example so that the open pores of the polymer foam are evacuated. This makes it possible to achieve an overall low thermal conductivity of the intermediate space 6.

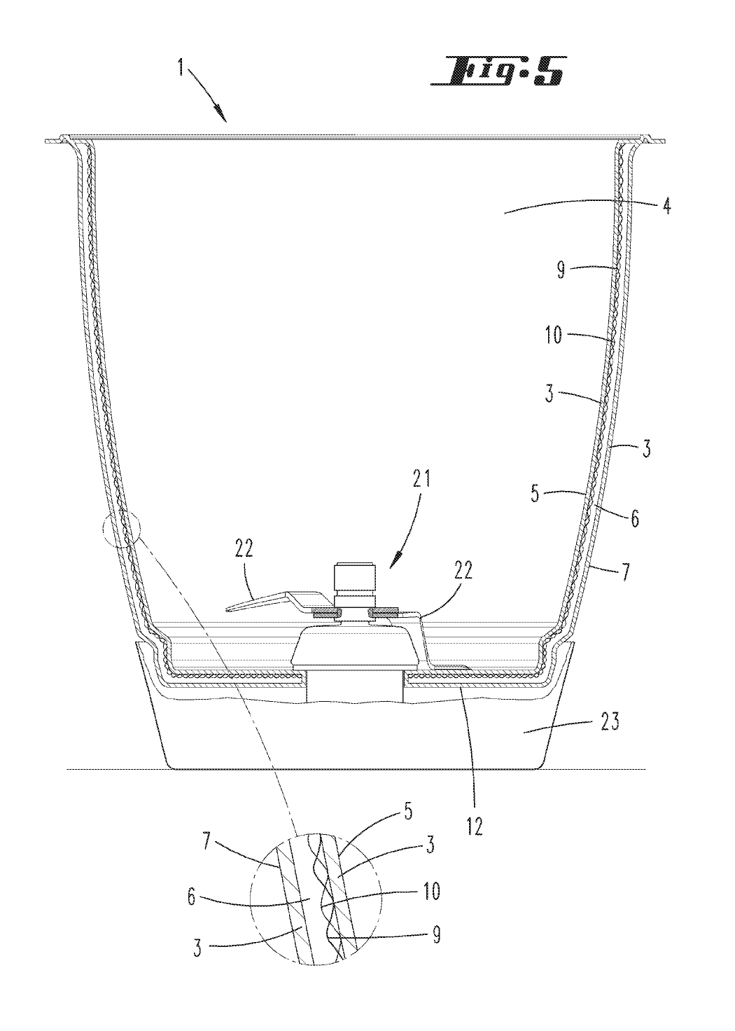

Finally, FIG. 5 shows another optional embodiment of a preparation vessel 1 according to the invention. The vessel wall 3 here has a heating device 9 and a cooling device 10 in both a circumferential area and the vessel floor 12. For example, the heating device 9 can consist of a resistance wire, Peltier elements or the like. For example, the cooling device 10 can have a canal system for cooling liquid, Peltier elements or the like. The coiled shape of the heating device 9 and cooling device 10 shown on FIG. 5 is only selected as an example. This does not limit the way in which the heating device 9 and cooling device 10 are configured. Both the heating device 9 and cooling device 10 are advantageously in contact with the inner wall 5, so that the thermal energy or cold can be released to the preparation chamber 4 or a preparation material located therein via the preferably thermally conductive inner wall 5. However, on the opposing side of the vessel wall 3, the heating device 9 and cooling device 10 are spaced apart from the outer wall 7, and are not in contact with the latter in a thermally conductive manner. A vacuum or insulating material 8 is preferably in the intermediate space 6 between the heating device 9 or cooling device 10 and the outer wall 7.

Because the heating device 9 is formed along the entire vessel wall 3, the preparation chamber 4 can be heated not only over the vessel floor 12, but over a complete surface area, so that the preparation material can be heated more uniformly and gently, and nutrient-protective cooking is ensured. The cooling device 10 makes it possible to prepare cold meals in addition to preparing hot meals. It is no longer necessary to put the preparation vessel 1 into a refrigerator, for example before whipping cream, preparing ice cream or mouse. The preparation vessel 1 or its preparation chamber 4 always stays cold, but because it is thermally decoupled from the outer wall 7, a user does not feel any effects of the cold on the outside of the outer wall 7.

Another embodiment similar to the embodiment according to FIG. 5 can also provide that the heating device 9 be in contact with the inner wall 5, while the cooling device 10 be in contact with the outer wall 7. During operation of the heating device 9, heat that might get to the outer wall 7 can be eliminated by the cooling device 10.

Apart from the exemplary embodiments shown above, other combinations involving a vacuum, insulating material 8 a heating device 9 and cooling device 10 are of course also possible.

### REFERENCE LIST

1 Preparation vessel

2 Food processor

3 Vessel wall

4 Preparation chamber

5 Inner wall

6 Intermediate space

7 Outer wall

8 Insulating material

9 Heating device

10 Cooling device

11 Base unit

12 Vessel floor

13 Heating device

14 Display

15 Switch

16 Cover

17 Cover opening

18 Cover handle

19 Vessel handle

20 Locking roller

21 Agitator

22 Knife

23 Vessel foot part

What is claimed is:

1. A preparation vessel for a food processor comprising a vessel wall, at least a partial area of which has a double-wall configuration, with an inner wall that borders a preparation chamber of the preparation vessel and an outer wall designed separately from the preparation chamber and spaced apart from the inner wall by an intermediate space, wherein the intermediate space has a vacuum with a gas pressure of less than 300 mbar and/or an insulating material with a thermal conductivity of less than 0.02 W/(mK).

2. The preparation vessel according to claim 1, wherein the gas pressure is less than 100 mbar.

3. The preparation vessel according to claim 1, wherein the intermediate space has the insulating material, and wherein the insulating material is comprised of a silica, an aerogel, an open-pore polymer foam and/or glass fibers.

4. The preparation vessel according to claim 1, wherein the vessel wall is a circumferential wall of the preparation vessel.

5. A preparation vessel for a food processor comprising a vessel wall, at least a partial area of which has a double-wall configuration, with an inner wall that borders a preparation chamber and an outer wall designed separately from the preparation chamber and spaced apart from the inner wall by an intermediate space, wherein the intermediate space accommodates a heating and/or cooling device that contacts the inner wall in a heat conducting manner.

6. The preparation vessel according to claim 5, wherein the heating device and/or cooling device is thermally insulated relative to the outer wall.

7. The preparation vessel according to claim 5, wherein the intermediate space between the outer wall and the heating and/or cooling device has a vacuum with a gas pressure of less than 300 mbar and/or an insulating material with a thermal conductivity of less than 0.02 W/(mK).

8. The preparation vessel according to claim 1, wherein the preparation vessel is configured to be connected with a base unit of a food processor, and has electrical connections for connection to a power supply of the base unit.

9. The preparation vessel according to claim 1, wherein a vessel floor of the preparation vessel has a heating and/or cooling device.

10. A food processor with a base unit and a preparation vessel according to claim 1, the preparation vessel being configured to be connected with the base unit.

11. The preparation vessel according to claim 5, wherein a vessel floor of the preparation vessel has a heating and/or cooling device.

12. The preparation vessel according to claim 5, wherein the preparation vessel is configured to be connected with a base unit of a food processor, and has electrical connections for connection to a power supply of the base unit.

13. The preparation vessel according to claim 5, wherein a vessel floor of the preparation vessel has a heating and/or cooling device.

14. A food processor with a base unit and a preparation vessel according to claim 5, the preparation vessel being configured to be connected with the base unit.

15. The preparation vessel according to claim 1, wherein the gas pressure is less than 50 mbar.
